(19) United States
(12) Patent Application Publication
(10) Pub. No.: US 2013/0223246 A1
(43) Pub. Date: Aug. 29, 2013

(54) COMMUNICATION METHOD, COMMUNICATION SYSTEM, AND MOBILE APPARATUS

(71) Applicant: PANTECH CO., LTD., (US)

(72) Inventor: In Youl LEE, Seoul (KR)

(73) Assignee: PANTECH CO., LTD., Seoul (KR)

(21) Appl. No.: 13/652,773

(22) Filed: Oct. 16, 2012

(30) Foreign Application Priority Data
Feb. 24, 2012 (KR) 10-2012-0019102

(51) Int. Cl. H04W 36/00; H04W 24/00

(52) U.S. Cl. 370/252; 370/331; 370/332

(57) ABSTRACT

In a communication method of a mobile apparatus, the mobile apparatus having fixed mobile IP information and performing data communication with a first base station transmits communication environment information of the first base station and a second base station capable of performing data communication with the mobile apparatus to the first base station. The mobile apparatus determines whether the communication environment information of the second base station is better than that of the first base station. While maintaining the fixed mobile IP information of the mobile apparatus, the mobile apparatus receives data, in which network IP information of a base station for transmitting data is changed to IP information of the second base station, from the first base station. At the mobile apparatus, a network IP of a base station for data communication is changed from the first base station to the second base station.

### CROSS-REFERENCE TO RELATED APPLICATION

This application claims priority from and the benefit under 35 U.S.C. § 119(a) of Korean Patent Application No. 10-2012-0019102, filed on Feb. 24, 2012, which is incorporated herein by reference for all purposes as if fully set forth herein.

### BACKGROUND

1. Field

The present disclosure relates to a communication method, a communication system, and a mobile apparatus and, more particularly, to a communication method, a communication system, and a mobile apparatus configured to perform handover based on network environments.

2. Discussion of the Background

A mobile station may move from a cell boundary of a first base station to a cell boundary of a neighboring base station (that is, a base station having a cell that neighbors the cell of the first base station) while establishing or maintaining a call or data connection. A mobile terminal automatically tunes to a new traffic channel of a neighboring base station such that handover of a radio frequency (RF) unit occurs while maintaining a call or data connection. In addition, a mobile IP for information communication between a mobile terminal and a base station is also changed, which is referred to as mobile IP handover.

Mobile IP handover of the related art used a home address of a home network and a care-of-address (COA) for a foreign network of a base station as a mobile IP for identifying a mobile terminal. More specifically, the care-of-address is changed while the home address is fixed to provide continuity of packets communicating between a mobile terminal and a home network. However, by changing the care-of-address, handover latency of about 15 ms or less may occur. Even when handover occurs, a mobile terminal transmits and receives various messages to and from a target base station. However, when a mobile terminal moves at a high speed or when a large amount of data is transmitted or received, the amount of data per unit time, that is, throughput, may decrease.

### SUMMARY

The following description relates to a communication method, a communication system and a mobile apparatus configured to perform handover based on network environments, and may be performed according to IPv6.

Additional features of the invention will be set forth in the description which follows, and in part will be apparent from the description, or may be learned by practice of the invention.

Exemplary embodiments of the present invention provide an apparatus, including a communication environment information measurement unit to measure first communication environment information of a first Base Transceiver Station (BTS) that is currently performing data communication with the apparatus and second communication environment information of a second BTS that is capable of performing data communication with the apparatus, a transmitter to transmit data comprising the first communication environment information and the second communication environment information, and a receiver to a receive a data packet including an instruction, the instruction instructing the apparatus to perform an IP handover from the first BTS to the second BTS according to the first communication environment information and the second communication environment information.

Exemplary embodiments of the present invention provide a method for communicating in a mobile apparatus, including performing data communication with a first base station, measuring first communication environment information of the first base station and measuring second communication environment information of a second base station, transmitting the first communication environment information and the second communication environment information to a home network via the first base station, receiving Internet Protocol (IP) information of the second base station if the second communication environment information corresponds to a better communication environment than the first communication environment information, changing a network IP for data communication from the first base station to the second base station, handing over from the first base station to the second base station, and performing data communication with the second base station.

Exemplary embodiments of the present invention provide a communication system, including a home network, a first Base Transceiver Station (BTS) and a second BTS, and a mobile apparatus including a communication environment information measurement unit to measure first communication environment information of the first BTS and second communication environment information of the second BTS. The mobile apparatus performs an

Internet Protocol (IP) handover from the first BTS to the second BTS according to the first communication environment information and the second communication environment information.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing an IPv6-based communication system to perform IPv6-based handover according to an exemplary embodiment of the present disclosure.

FIG. 2 is a diagram showing an internal configuration of a mobile apparatus according to an exemplary embodiment of the present disclosure.

FIG. 3 is a diagram showing a relationship between components of a communication system according to an exemplary embodiment of the present disclosure.

FIG. 4A is a diagram showing a configuration of a packet transmitted from the Internet to a home network according to an exemplary embodiment of the present disclosure.

FIG. 4B is a diagram showing a configuration of a packet transmitted from a home network to a foreign network according to an exemplary embodiment of the present disclosure.

FIG. 4C is a diagram showing a configuration of a packet transmitted from a home network to a foreign network according to an exemplary embodiment of the present disclosure.

FIG. 4D is a diagram showing a configuration of a packet transmitted from a foreign network to a mobile apparatus according to an exemplary embodiment of the present disclosure.

FIG. 4E is a diagram showing a configuration of a packet transmitted from a foreign network to a mobile apparatus according to an exemplary embodiment of the present disclosure.

FIG. 5A is a diagram showing a configuration of a packet transmitted from a home network to a first foreign network according to an exemplary embodiment of the present disclosure.

FIG. 5B is a diagram showing a configuration of a packet transmitted from a home network to a second foreign network according to an exemplary embodiment of the present disclosure.

FIG. 5C is a diagram showing a configuration of a packet transmitted from a home network to a third foreign network according to an exemplary embodiment of the present disclosure.

FIG. 6A is a diagram showing a configuration of a packet transmitted from a home network to a foreign network using a fixed mobile IP according to an exemplary embodiment of the present disclosure.

FIG. 6B is a diagram showing a configuration of a packet transmitted from a home network to a foreign network using a flexible mobile IP according to an exemplary embodiment of the present disclosure.

### DETAILED DESCRIPTION OF THE ILLUSTRATED EMBODIMENTS

The present disclosure will now be described more fully hereinafter with reference to the accompanying drawings, in which exemplary embodiments are shown. The invention may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments. The terminology used herein is for the purpose of describing particular embodiments only and is not intended to be limiting of the present disclosure. Unless otherwise defined, all terms (including technical and scientific terms) used herein have the same meaning as commonly understood by one of ordinary skill in the art. While the present disclosure has been described with respect to the exemplary embodiments, it will be apparent to those skilled in the art that various changes and modifications may be made without departing from the spirit and scope of the disclosure as defined in the following claims and their equivalents. Throughout the drawings and the detailed description, unless otherwise described, the same reference numerals are understood to refer to the same elements, features, and structures. The shape, size and regions, and the like, of the drawing may be exaggerated for clarity. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

Initially, Internet Protocol version 6 (IPv6) will be described. IPv6 refers to an IP address system which has been developed in order to improve demerits of IPv4, which is currently being used. IPv6 was developed by the Internet Engineering Task Force (IETF) and is also called IP next generation (IPng) in terms of a next-generation Internet communication protocol.

IPv6 is different from IPv4, and at least a portion of those differences will be described in more detail now. IPv4 addresses are 32 bits long, number about 4.2 billion, and are allocated based on Classless Inter-Domain Routing (CIDR) of A, B, C and D. In contrast, IPv6 addresses are 128 bits long, number about number about 3.4×10³⁸, and are hierarchically allocated based on CIDR. There are three address types, referred to as unicast, multicast and anycast. Unicast refers to a method of transmitting data packets to a specific node of one node. Multicast refers to a method of simultaneously transmitting the same data to several nodes of a specific group. Anycast refers to a method of enabling one end node to communicate with a nearest node among a plurality of nodes.

An IPv6 address is not represented by a 12-digit number such as 129.232.123.123 as in IPv4, but is represented in a binary format. That is, the IPv6 address is represented by 128 bits such as 00100001110110101001000 . . . 11010 and a 128-bit address is divided by 16 bits (0010000111011010). A 16-bit block is translated to a hexadecimal number and is separated by colon, such as 21DA:00D3:0000:2F3B:02AA:00FF:FE28:9C5A. A simpler address such as 21DA:D3:0:2F3B:2AA:FF:FE28:9C5A may be obtained by removing 0 from 21DA:00D3:0000:2F3B:02AA:00FF:FE28:9C5A. In this case, since one digit is included in each block, one 0 is left when only 0 is included in one block. An IP address system with improved network extendability by increasing an address space may be applicable to mobile phones or electronic appliances. IPv6 is commonly considered to have advantages over IPv4 including 1) an increase in network speed, 2) provision of a higher-quality service through specific packet recognition, and 3) packet source authentication through header extension, data integrity and guarantee of confidence.

Further, in IPv6, the length of the IP address is increased to 128 bits, in order to prepare for increased Internet use. Through IPv6, an IP address is applicable to a mobile apparatus or a network. The present disclosure describes allocating a semi-permanent unique IP to each mobile apparatus and network via substantially increased IP resources in association with introduction of IPv6.

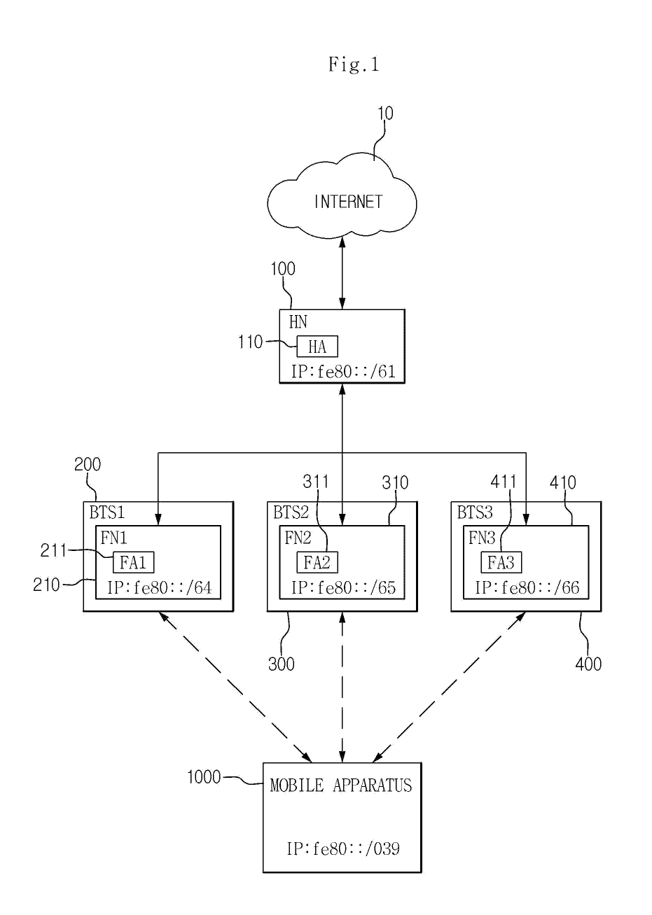

FIG. 1 is a diagram showing an IPv6-based communication system to perform IPv6-based handover according to an exemplary embodiment of the present disclosure.

Referring to FIG. 1, a communication system includes the Internet 10, a home network (HN) 100, base transceiver stations (BTSs) including BTS1 200, BTS2 300, and BTS3 400, and a mobile apparatus 1000. Although the communication system of FIG. 1 is described as including the Internet 10, the communication system may include the HN 100 and the BTSs 200, 300, and 400, and the communication system may be connected via a network connection to the Internet 10. A mobile apparatus 1000 may operate within the communication system.

The Internet 10 is a communication network and may be a wired or wireless network. The Internet 10 may include or be connected to one or more communication networks such as a local area network (LAN), a metropolitan area network, a wide area network (WAN), etc. The Internet 10 may include or be connected to the world wide web (WWW). The Internet 10 may communicate with one or more home networks (HNs) and may communicate with one or more BTSs 200, 300 and 400 and the mobile apparatus 1000, which is connected to a BTS, via the home network 100.

The HN 100 is a network to apply a home address to the mobile apparatus 1000. Under an IPv6 scheme, the home address is a unique IP address of the HN 100 for accessing the Internet 10 of a higher level and is not changed even when the mobile apparatus 1000 is handed over from a first cell to a second cell neighboring the first cell. In FIG. 1, the home address of the HN is represented by IP:fe80::/61. The HN 100 is connected to the Internet 10 and is connected to at least one BTS. As shown in FIG. 1, the HN 100 is connected to BTS1 200, BTS2 300, and BTS3 400, and, more specifically, to foreign networks (FN) shown as FN1 210, FN2 310, and FN3 410, respectively included in BTS1 200, BTS2 300, and BTS3 400. The HN 100 may include a home agent (HA) 110.

The HA 110 is located inside the HN 100, functions as a router and stores IP information fe80::/039 about the mobile apparatus 1000. The HA 110 may store IP information fe80::/64, fe80::/65, and fe80::/66 of FN1 210, FN2 310, and FN3 410, respectively.

BTS1 200, BTS2 300, and BTS3 400 are configured and available to relay communications between the HN 100 and the mobile apparatus 1000. In general, a range in which a radio wave is reached to perform communication is referred to as a “zone” and one service region is divided into a plurality of small zones referred to as cells. The BTS 1 200, BTS2 300, and BTS3 400 function as relays between the mobile apparatus 1000 and the HN 100. One BTS exists in each cell. As such, BTS1 200, BTS2 300, and BTS3 400 are respectively arranged in three cells to function as relays between the mobile apparatus 1000 and the HN 100. The BTS 1 200, BTS2 300, and BTS3 400 control and manage respective cells using an incoming/outgoing call transmission function, a traffic channel designation function, a traffic channel monitoring function, a self-diagnosis function, etc.

In addition, BTS 1 200, BTS2 300, and BTS3 400 each receive information about a communication environment (level, noise, etc. of a radio communication signal) of each of the plurality of BTSs 200, 300, and 400, from a mobile apparatus 1000, compare a communication environment of a BTS with which communication is currently being performed with a communication environment of a neighboring BTS upon movement of the mobile apparatus, and handover the mobile apparatus 1000 to a BTS having a good communication environment (handover of a physical layer). That is, BTS 1 200, BTS2 300, and BTS3 400 each perform handover of an RF unit.

Information about a communication environment includes information about a communication environment of a physical layer (radio frequency environment). The physical layer is a lowest layer of a protocol layer and serves to manage a radio communication environment, that is, to manage a radio carrier and a modulation scheme of data to be transmitted to establish packet communication. More specifically, the information about the communication environment may include a distance between a BTS and a mobile apparatus, a signal level, a signal-to-noise ratio (SNR) of a signal, a signal-to-interference plus noise ratio (SINR) of a signal, and a signal-to-noise plus distortion ratio (SNDR) of a signal.

As explained above, FN1 210, FN2 310, and FN3 410 are respectively arranged in BTS1 200, BTS2 300, and BTS3 400. The FN1 210, FN2 310, and FN3 410 are referred to as “foreign” since these are networks that are changed when handover of an RF unit occurs and thus the mobile apparatus 1000 performs handover of a mobile IP (when a previously established communication channel is changed). The FN1 210, FN2 310, and FN3 410 have respective unique IP addresses allocated thereto. The HN 100 may be aware of the IPs of the foreign networks FN1 210, FN2 310, and FN3 410 connected to the HN 100. If the HN 100 is not aware of the IPs of FN1 210, FN2 310, and FN3 410, then FN1 210, FN2 310, and FN3 410 may transmit information about the IPs of FN1 210, FN2 310, and FN3 410 via communication with the HN 100 upon handover. As described above, the FN1 210, FN2 310, and FN3 410 receive communication environment information of a plurality of BTSs and change the IPs of FN1 210, FN2 310, and FN3 410 of transmitted/received data to change the BTSs if mobile IP handover of the mobile apparatus 1000 among the BTSs 200, 300 and 400 is to occur. A more detailed explanation will be described below.

The foreign agents (FA), including FA1 211, FA2 311, and FA3 411, are respectively arranged inside FN1 210, FN2 310, and FN3 410 to serve as routers and to IP store information including fe80::/039 about the mobile apparatus 1000 and middle IPs fe80::/64, fe80::/65, and fe80::/66 about FN1 210, FN2 310, and FN3 410.

The mobile apparatus 1000 may be implemented in one of various forms and may include various features. The mobile apparatus 1000 may include any apparatus configured to execute a specific application and the form thereof is not limited. An application, that is, a program, may be executed using the mobile apparatus 1000 and a camera function, a memory function, an operation function, etc. of the mobile apparatus 1000 may be used. For example, the mobile apparatus 1000 may include a handheld wireless terminal such as a personal communication system (PCS), Global System for Mobile communications (GSM), Personal Digital Cellular (PDC), a Personal Handyphone System (PHS), a Personal Digital Assistant (PDA), and an International Mobile Telecommunication (IMT)-2000 terminal. In particular, the mobile apparatus 1000 may be a smart phone, an e-book reader, a tablet computer, or the like, and may include a display, one or more of a variety of sensors such as a touch sensor, a vibration motor, a speaker, a communication module, etc. or a small smart pad. The mobile apparatus 1000 may include a processor, an operating system, and an application program interface (API), and may include a processing system to provide communication between one or more software applications and the operating system. Further, the processing system of the mobile apparatus 1000 may be configured to execute a variety of software applications.

The mobile apparatus 1000 may communicate with another object and include hardware or software installed therein to perform communication. A communication method may include one or more of various communication methods between objects and is not limited to wired/wireless communication, 3G, 4G, LTE, or other methods. Transmittable/receptible information including information about various sensors included in the mobile apparatus 1000, voice feedback information, and vibration feedback information may be transmitted to an external object or may be received from an internal component. The communication method may include communication via a Local Area Network (LAN), Metropolitan Area Network (MAN), Global System for Mobile Network (GSM), Enhanced Data GSM Environment (EDGE), High Speed Downlink Packet Access (HSDPA), Wideband Code Division Multiple Access (W-CDMA), Code Division Multiple Access (CDMA), Time Division Multiple Access(TDMA), Bluetooth, Zigbee, Wi-Fi, Voice over Internet Protocol (VoIP), LTE Advanced, IEEE802.16m, WirelessMAN-Advanced, HSPA+, 3GPP Long Term Evolution (LTE), Mobile WiMAX (IEEE 802.16e), UMB (formerly EV-DO Rev. C), Flash-OFDM, iBurst and MBWA (IEEE 802.20) systems, HIPERMAN, Beam-Division Multiple Access (BDMA), World Interoperability for Microwave Access (Wi-MAX) and ultrasonic communication, but is not limited thereto.

The operating system of the mobile apparatus 1000 may be Android provided by Google, Blackberry OS provided by RIM, iOS provided by Apple, Symbian OS provided by Nokia, Windows Mobile provided by Microsoft Corporation, or bada provided by Samsung Electronics, but is not limited thereto.

The unique fixed mobile IP information is allocated to each mobile apparatus 1000. The fixed mobile IP information may be IPv6-based IP information. IPv6 may be semi-permanently used as described above and thus may be permanently allocated to a mobile apparatus 1000. Since IPv6-based IP information may be used to distinguish between mobile apparatuses 1000 through an International Mobile Equipment Identity (IMEI) and an International Mobile Subscriber Identity (IMSI) of a mobile apparatus, the fixed mobile IP is allocated to a mobile apparatus 1000.

The IMEI may be unique information to identify a GSM, CDMA, iDEN mobile s phone or a satellite phone and may not permanently or semi-permanently have a relationship with a user of a mobile phone. That is, the IMEI contains only information about a device and thus may not be changed unless hardware is changed. For example, the IMEI may include a combination of communication cooperation (origin), a model or revision, a serial number of a device, and a check digit.

The IMSI is a unique identity of a user of a mobile apparatus of a GSM and Universal Mobile Telecommunications System (UMTS) network. The IMSI is stored as 64 bits of a subscriber identity module (SIM) card included in a mobile apparatus and is transmitted to a network by the mobile apparatus. The IMSI is represented by a number of 15 digits or shorter. A first three-digit code of the IMSI represent a mobile country code (MCC), and a subsequent 2-digit (European Standard) or 3-digit (North America standard) code is a mobile network code (MNC). The length of the MNC is based on the value of the MCC. The remaining code represents a mobile subscription identification number (MSIN) based on a user of a network.

The mobile apparatus 1000 may have a plurality of pieces of mobile IP information. The mobile apparatus 1000 may fundamentally include the above-described fixed mobile IP information and additionally include flexible mobile IP information. A data communication path is added and may increase communication efficiency according to the communication state of the mobile apparatus 1000. The flexible mobile IP information may be allocated by foreign agents such as FA1 211, FA2 311, and FA3 411. In this case, the FA1 211, FA2 311, and FA3 411 may report information about allocation of the flexible mobile IP to the HN 100. Thus, the mobile apparatus 1000 may flexibly set radio frequency resources, that is, a bandwidth of a frequency domain according to a communication environment.

The fixed mobile IP information and the flexible mobile IP information based on IPv6 will be described in more detail now through the actual IMEI and IMSI of the mobile apparatus 1000. For example, it is assumed that a mobile phone of Pantech used by a user is AA-BBBBBB-CCCCCC-D and an IMSI thereof is 450055505601234. Here, 450 of the IMSI is an MCC representing Korea, 05 is an MNC of SK Telecom, and 5505601234 is an MSIN. Samsung Electronics, which is a manufacturer, and SK Telecom, which is a communication cooperation or carrier, may allocate fe80::2458:e552:2442:6f52 to an IMSI of 450055505601234 as fixed mobile IP information. The fixed mobile IP may be managed by the manufacturer or the communication corporation.

A plurality of pieces of flexible mobile IP information may be allocated so as to add a data communication path. As described above, the flexible mobile IP information may be allocated by FA1 211, FA2 311, and FA3 411. The newly added flexible mobile IP information may include one piece of IP information of fe80::2458:e552:2442:6f55. Alternatively, the newly added flexible mobile IP information may include a plurality of pieces of IP information such as fe80::2458:e552:2442:6f56, fe80::2458:e552:2442:6f57, and fe80::2458:e552:2442:6f58.

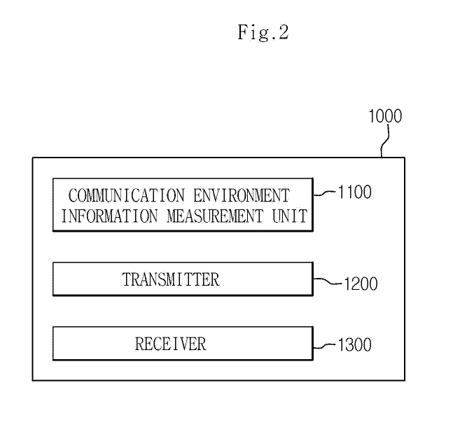

FIG. 2 is a diagram showing an internal configuration of a mobile apparatus according to an exemplary embodiment of the present disclosure.

Referring to FIG. 2, the mobile apparatus 1000 may include a communication environment information measurement unit 1100, a transmitter 1200, and a receiver 1300.

The communication environment information measurement unit 1100 measures communication environment information of a BTS that is currently performing data communication with the mobile apparatus and a BTS that is capable of performing data communication. As described above, communication environment information includes information about a radio frequency environment of a physical layer, and the physical layer is a lowest layer of a protocol layer and serves to manage a radio communication environment. More specifically, the communication environment information may include a distance between a BTS and a mobile apparatus, a signal level, and an SNR, SNIR and SNDR of a signal. Handover of the physical layer, that is, handover of an RF unit, occur based on the communication environment information measurement value of the communication environment information measurement unit 1100. As described above, the communication environments of the BTSs, including BTS1 200, BTS2 300, and BTS 3 400 are compared so that the mobile apparatus 1000 may change to a BTS having a better communication environment among the compared BTSs.

The transmitter 1200 and the receiver 1300 are configured to perform a communication function of the mobile apparatus 1000. The transmitter 1200 and the receiver 1300 may transmit and receive data using a communication technique such as HSDPA, W-CDMA, CDMA or TDMA. The transmitted data includes communication environment information with a BTS.

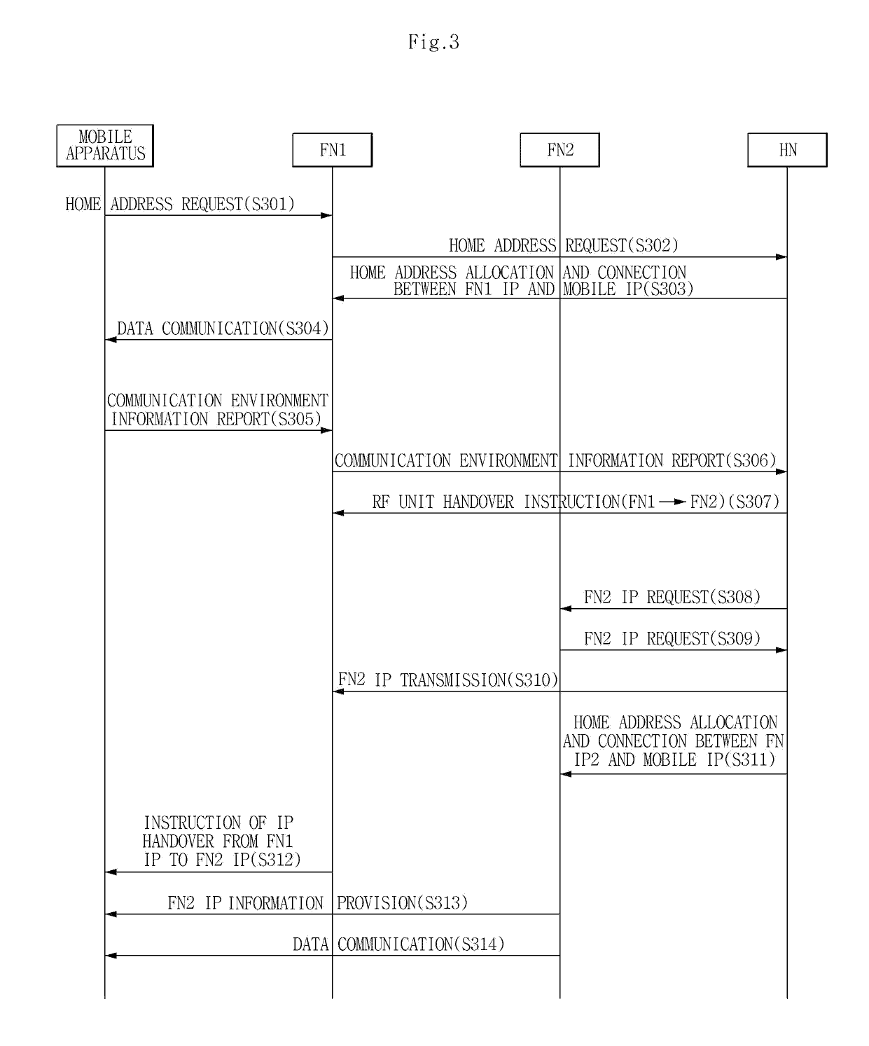

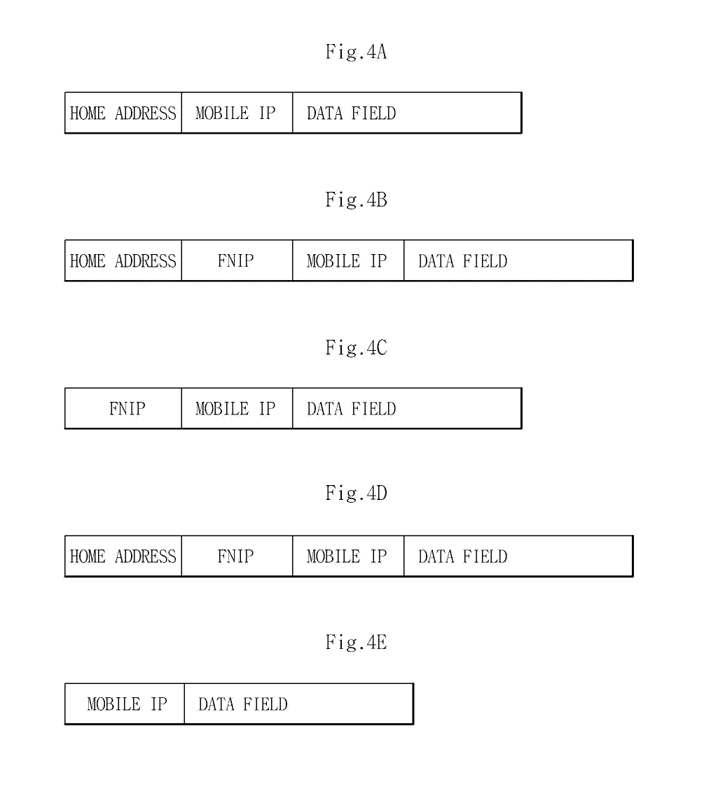

FIG. 3 is a diagram showing a relationship between components of a communication system according to an exemplary embodiment of the present disclosure. FIG. 4A is a diagram showing a configuration of a packet transmitted from the Internet to a home network according to an exemplary embodiment of the present disclosure. FIG. 4B is a diagram showing a configuration of a packet transmitted from a home network to a foreign network according to an exemplary embodiment of the present disclosure. FIG. 4C is a diagram showing a configuration of a packet transmitted from a home network to a foreign network according to an exemplary embodiment of the present disclosure. FIG. 4D is a diagram showing a configuration of a packet transmitted from a foreign network to a mobile apparatus according to an exemplary embodiment of the present disclosure. FIG. 4E is a diagram showing a configuration of a packet transmitted from a foreign network to a mobile apparatus according to an exemplary embodiment of the present disclosure.

FIG. 3 will be described as if performed by the system shown in FIG. 1, but is not limited as such. Further, FIG. 3 will be described in view of FIGS. 4A-4E as discussed below.

In S301, S302, S303, and S304, a method for establishing initial data communication between the mobile apparatus 1000 and the foreign network 1 (FN1) 210 of the base station 1 (BTS1) 200 is performed. The mobile apparatus 1000 may transmit mobile IP information to the HN 100 via the FN1 210 before operation S301 and the HN 100 may authenticate the mobile IP (not shown). The mobile apparatus 1000 then requests a home address from the FN1 210 (S301). The FN1 210 transmits a home address request to the HN 100 (S302) in response to operation S301, and the HN 100 allocates a home address to the mobile apparatus 1000 via the FN1 210 and connects the IP of the FN1 and the mobile IP (S303). Thus, the mobile apparatus 1000 and the FN1 200 are set in a data communication state (S304).

If data communication between the mobile apparatus 1000 and the FN1 is established in S304, the mobile apparatus 1000 and the FN1 transmit and receive data to and from each other using the mobile IP and the FN1 IP. Referring to FIG. 4A, the structure of a data packet transmitted from the Internet 10 to the HN 100 will be described in more detail. The structure of the data packet is divided into a data field to be transmitted and the other part. The other part includes information about communication. The other part may be used as a header of data. The other part includes a home address for identifying the HN 100, and mobile IP information for identifying the mobile apparatus 1000.

Referring to FIG. 4B, the structure of a data packet transmitted from the HN 100 to the foreign networks including FN1 210, FN2 310, and FN3 410 will be described in more detail. This structure is different from the structure of FIG. 4A in that an FN IP, that is, an IP of a foreign network, is included. A specific FN among FN1 210, FN2 310, and FN3 410 connected to one HN 100 may be specified through the FN IP to transmit data. Referring to FIG. 4C, the home address is not included, unlike as shown in FIG. 4B. If the HN 100 transmits data to the FN1 210, FN2 310, and FN3 410, since the same HN 100 operates with each of FN1 210, FN2 310, and FN3 410, the common home address may be omitted as shown in FIG. 4C. If the home address is omitted, since the size of the transmitted data packet may be reduced, it may be possible to increase transmission efficiency.

Referring to FIG. 4D, the structure of a data packet transmitted from the FN1 210 to the mobile apparatus 1000 will be described in more detail. The structure of the data packet transmitted from the FN 210 to the mobile apparatus 1000 may be identical to that of FIG. 4B. However, referring to FIG. 4E, the home address and the FN IP are not included, unlike as shown in FIG. 4D. If data is transmitted from the FN1 210 to the mobile apparatus 1000, since the FN1 210 may only operate with the HN 100, the common home address and FN IP may be omitted. As described above, since the size of the transmitted data packet may be reduced, it is possible to increase transmission efficiency.

Referring back to FIG. 3, in S305, S306, S307, S308, S309, S310, S311, S312, S313, and S314, a method for performing RF handover of a physical layer and handover of a mobile IP according to change in communication environment information is performed. First, the mobile apparatus 1000 measures communication environment information between the mobile apparatus 1000 and the FN1 210, which is currently performing communication, and an FN2 310 and FN3 410, which are capable of performing communication with the mobile apparatus 1000, the mobile apparatus 1000 transmits the communication environment information to the FN1 210 currently performing communication, and, at substantially the same time, reports the communication environment information to the HN 100 via the FN1 210 (S305, S306). The HN 100 analyzes the communication environment information and instructs handover of an RF communication from the FN1 210 to the FN2 310 in order to maintain a physical communication channel if it is determined that the FN2 310 is the better communication environment among the FN1 210, the FN2 310, and the FN3 410 based on the communication environment information from the mobile apparatus 1000 (S307). If the FN is changed according to the instruction from the HN 100, the mobile apparatus 1000 performs RF communication with the FN2 310. Thereafter, for mobile IP handover for data communication, the HN 100 allocates a home address via the FN2 310 similarly to the process described for S303 so as to connect the mobile apparatus 1000 and the FN2 (S311). Alternatively, if the FN1 210 does not obtain the IP information of the FN2 310, the HN 100 requests the FN2 IP from the FN2 310 (S308) and the FN2 310 sends the FN2 IP to the HN 100 (S309). The FN1 210 then changes the FN1 IP stored in the data packet to the FN2 IP based on the FN2 IP transmission received from the HN 100 (S310) and transmits the FN2 IP to the mobile apparatus 1000 so as to instruct the mobile apparatus 1000 to perform mobile IP handover from FN1 IP to FN2 IP (S312). Thereafter, the FN2 310 may provide the FN2 IP information to the mobile apparatus 1000 (S313). As shown in FIG. 4D, the data transmitted from a specific foreign network to the mobile apparatus 1000 includes IP information of the foreign network. Finally, the FN2 310 and the mobile apparatus 1000 are connected for data communication. The network IP information of the BTS, which is included in the data to be transmitted by the mobile apparatus 1000, may be changed from FN1 IP to FN2 IP.

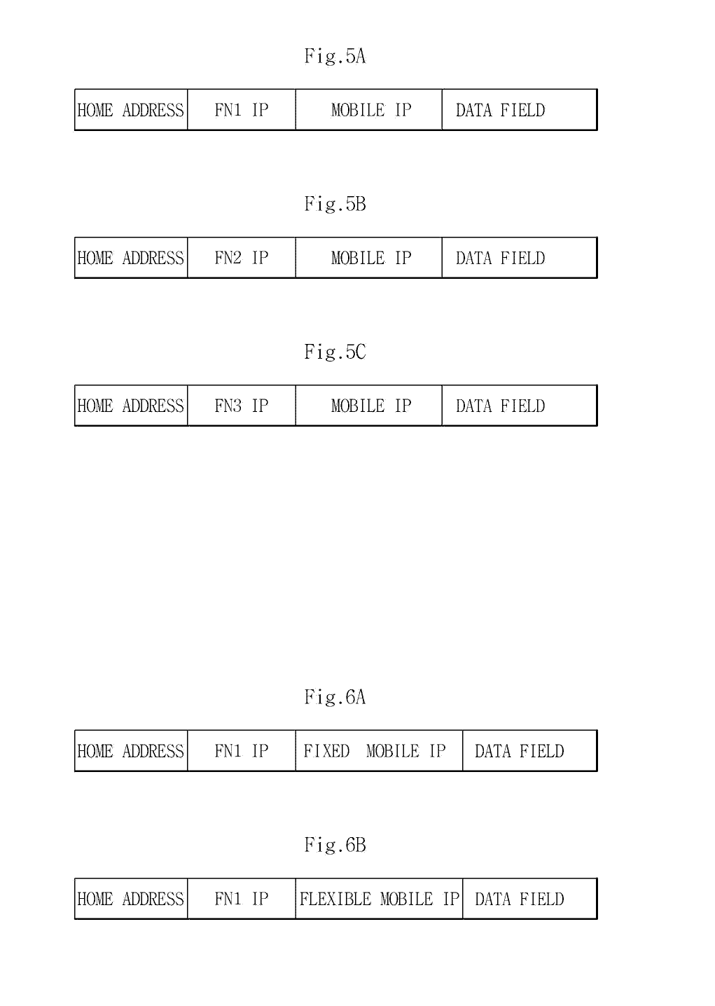

FIG. 5A is a diagram showing a configuration of a packet transmitted from a home network to a first foreign network according to an exemplary embodiment of the present disclosure. FIG. 5B is a diagram showing a configuration of a packet transmitted from a home network to a second foreign network according to an exemplary embodiment of the present disclosure. FIG. 5C is a diagram showing a configuration of a packet transmitted from a home network to a third foreign network according to an exemplary embodiment of the present disclosure.

Referring to FIG. 5A, FIG. 5B, and FIG. 5C, the structure of a data packet transmitted from the HN 100 to FN1 210, FN2 310, and FN3 410, respectively, when the FN (BTS) is changed is shown. The home address, the mobile IP and the data field are the same, but the FN IP part is changed in order of FN1 IP, FN2 IP and FN3 IP according to the foreign network with which the mobile apparatus 1000 performs the data communication.

FIG. 6A is a diagram showing a configuration of a packet transmitted from a home network to a foreign network using a fixed mobile IP according to an exemplary embodiment of the present disclosure. FIG. 6B is a diagram showing a configuration of a packet transmitted from a home network to a foreign network using a flexible mobile IP according to an exemplary embodiment of the present disclosure.

FIG. 6A and FIG. 6B show the structure of a data packet transmitted from the HN 100 to one of the FN1 210, FN2 310, and FN3 410 when the above-described fixed mobile IP information and flexible mobile IP information are used, respectively. A data communication path is added, which may increase communication efficiency according to a communication state of the mobile apparatus 1000. The flexible mobile IP information may be allocated by the foreign network, such as FN1 210, FN2 310, and FN3 410. In this case, the foreign agent, such as FA1 211, FA2 311, and FA3 411, may report information about allocation of the flexible mobile IP information to the HN 100. Thus, the mobile apparatus 1000 may set radio frequency resources, that is, a bandwidth of a frequency domain according to a communication environment.

According to exemplary embodiments of the present disclosure, it may be possible to reduce or minimize handover latency by changing a foreign network IP of a base station and maintaining a mobile apparatus IP.

In addition, it may be possible to implement a technique for transmitting a larger amount of data and higher-speed data communication due to development of a communication technique, by minimizing or reducing handover latency.

It may be possible to efficiently use extended IP resources by introducing IPv6.

While the exemplary embodiments have been shown and described, it will be understood by those skilled in the art that various changes in form and details may be made thereto without departing from the spirit and scope of the present disclosure as defined by the appended claims and their equivalents.

In addition, many modifications can be made to adapt a particular situation or material to the teachings of the present disclosure without departing from the essential scope thereof. Therefore, it is intended that the present invention cover the modifications and variations of this invention provided they come within the scope of the appended claims and their equivalents.

What is claimed is:

1. An apparatus, comprising:
a communication environment information measurement unit to measure first communication environment information of a first Base Transceiver Station (BTS) that is currently performing data communication with the apparatus and second communication environment information of a second BTS that is capable of performing data communication with the apparatus;
a transmitter to transmit data comprising the first communication environment information and the second communication environment information; and
a receiver to a receive a data packet comprising an instruction, the instruction instructing the apparatus to perform an IP handover from the first BTS to the second BTS according to the ii first communication environment information and the second communication environment information.

2. The apparatus of claim 1, wherein the apparatus transmits a home address request to a home network via a first foreign network associated with the first BTS to establish data communication with the first BTS.

3. The apparatus of claim 2, wherein a data packet transmitted between the internet and the home network comprises mobile Internet Protocol (IP) information identifying the apparatus and the home address of the home network.

4. The apparatus of claim 3, wherein a data packet transmitted between the home network and the first foreign network associated with the first BTS comprises the mobile Internet Protocol (IP) information identifying the apparatus, and an Internet Protocol (IP) of the first foreign network (FN IP).

5. The apparatus of claim 4, wherein the data packet transmitted between the home network and the first foreign network associated with the first BTS further comprises the home address of the home network.

6. The apparatus of claim 5, wherein the data packet transmitted between the first foreign network associated with the first BTS and the apparatus comprises the home address of the home network, the mobile IP information identifying the apparatus, and the FN IP of the first foreign network.

7. The apparatus of claim 5, wherein the data packet transmitted between the first foreign network associated with the first BTS and the apparatus comprises the mobile IP information identifying the apparatus.

8. The apparatus of claim 1, wherein the first communication environment information comprises information about a radio frequency environment of a physical layer associated with the first BTS.

9. The apparatus of claim 8, wherein the first communication environment information comprises at least one of a distance between the first BTS and the apparatus, a signal level of a signal communicated between the first BTS and the apparatus, a Signal-to-Noise Ratio, a Signal-to-Noise-and-Interference Ratio, and a Signal-to-Noise-plus-Distortion Ratio.

10. The apparatus of claim 1, wherein the second communication environment information of the second BTS is determined to have a better communication environment than the first communication environment information of the first BTS.

11. A method for communicating in a mobile apparatus, comprising:
performing data communication with a first base station;
measuring first communication environment information of the first base station and measuring second communication environment information of a second base station;
transmitting the first communication environment information and the second communication environment information to a home network via the first base station;
receiving Internet Protocol (IP) information of the second base station if the second communication environment information corresponds to a better communication environment than the first communication environment information;
changing a network IP for data communication from the first base station to the second base station;
handing over from the first base station to the second base station; and
performing data communication with the second base station.

12. The method of claim 11, wherein the IP information of the second base station is received from the second base station.

13. The method of claim 11, wherein performing data communication with the second base station comprises inserting the IP information of the second base station in data packets transmitted from the mobile apparatus to the second base station.

14. A communication system, comprising:
a home network;
a first Base Transceiver Station (BTS) and a second BTS; and
a mobile apparatus comprising a communication environment information measurement unit to measure first communication environment information of the first BTS and second communication environment information of the second BTS, wherein the mobile apparatus performs an Internet Protocol (IP) handover from the first BTS to the second BTS according to the first communication environment information and the second communication environment information.

15. The communication system of claim 14, wherein the first communication environment information comprises information about a radio frequency environment of a physical layer associated with the first BTS, and the second communication environment information comprises information about a radio frequency environment of a physical layer associated with the second BTS.

16. The communication system of claim 15, wherein the first communication environment information comprises at least one of a distance between the first BTS and the mobile apparatus, a signal level of a signal communicated between the first BTS and the mobile apparatus, a Signal-to-Noise Ratio, a Signal-to-Noise-and-Interference Ratio, and a Signal-to-Noise-plus-Distortion Ratio.

17. The communication system of claim 14, wherein the mobile apparatus performs the IP handover from the first BTS to the second BTS if the second communication environment information of the second BTS is determined to correspond to a better communication environment than the first communication environment information of the first BTS.

18. The communication system of claim 14, wherein the mobile apparatus continues to perform a data communication with the first BTS without performing the IP handover from the first BTS to the second BTS if the first communication environment information of the first BTS is determined to correspond to a better communication environment than the second communication environment information of the second BTS.

19. The communication system of claim 14, wherein the communication environment information measurement unit measures the second communication environment information of the second BTS if the second BTS is capable of performing data communication with the mobile apparatus.

20. The communication system of claim 14, wherein mobile Internet Protocol (IP) information associated with the mobile apparatus is flexible mobile IP information based on Internet Protocol version 6 (IPv6).
